(19) United States
(12) Patent Application Publication
(10) Pub. No.: US 2021/0012301 A1
(43) Pub. Date: Jan. 14, 2021

(54) USB DATA CARD AND METHOD OF USING SAME

(71) Applicant: RAJ MANANSINGH, TAMPA, FL (US)

(72) Inventor: RAJ MANANSINGH, TAMPA, FL (US)

(21) Appl. No.: 17/035,402

(22) Filed: Sep. 28, 2020

Related U.S. Application Data
(63) Continuation-in-part of application No. 15/886,177, filed on Feb. 1, 2018.
(60) Provisional application No. 62/510,217, filed on May 23, 2017.

(51) Int. Cl. G06Q 20/12; H01R 13/44; G06Q 20/34; G06Q 30/02; G06Q 10/10; G06K 19/07; G06F 13/42

(52) U.S. Cl. CPC G06Q 20/1235; H01R 13/44; G06Q 20/352; G06Q 30/0205; G06F 2213/0042; G06K 19/0723; G06F 13/4282; G06Q 2220/145; G06Q 10/109

(57) ABSTRACT

A card for distributing media including any one or all of music, videos and movies said card include a main card body formed of two covers that snap or nestle together about its perimeter. One or more chips are nestled internally within the main card body and are configured to transmit information. A USB male connector is configured to pivot relative to the main card body so as to operate between a retracted position and an extended position. The USB male connector is coupled to a dongle configured to pivot about an axis relative to the main card body. The USB male connector includes executable instructions to communicate with a remote third party notifying the time and location of access to stored information.

### CROSS REFERENCE TO RELATED APPLICATIONS

This application claims the benefit of earlier filing date and right of priority to U.S. Provisional Application No. 62/510,217, filed May 23, 2017, and is a continuation-in-part of U.S. patent application Ser. No. 15/886,177, filed 1 Feb. 2018, the contents of which is incorporated by reference herein in its entirety.

### BACKGROUND OF THE INVENTION

### 1. Field of the Invention

The present application relates to a device and method for data storage, and more particularly to a USB data card holding a plurality of chips.

### 2. Description of Related Art

There are various methods or devices used to store and transmit data. Electronically, data may be stored on a USB drive commonly used in the public. These devices are housed in 1-piece molded plastic housings. They are typically only able to communicate with a particular computer platform. To manufacture, the housings would be bulky. The chip inside would be laser cut or molded into the interior of the body. Such is feasible where the bodies are thick, but not so feasible where the body thickness is minimal, such as 1-2 mm. Although strides have been made, shortcomings remain.

### BRIEF SUMMARY OF THE INVENTION

It is an object of the present application to provide a USB data card configured to hold data, including music, movies, videos, and other data varieties that is suitable for communicating on MAC, Windows, tablet, Android phone, or Smart TV. The USB data card includes a housing consisting of 2 layers that join together to surround a plurality of types of chips. The chips receive and transmit data with remote electronic devices (i.e. a computer). Data can be stored on the USB data card and transmitted to initiate programs. Data transfers from and to the card may be transmitted to third party devices to track information and usage.

An object of the present application is to provide a housing that incorporates both USB drives and other chips that could securely fit into a plastic body housing approximately the size of a business card. The housing preferably is formed by the coupling of two opposing layers via an interlocking channel. The chips are stored inside the two opposing layers. A plurality of cavities are formed internally for the holding of the plurality of chips. The cavities are spaced from one another so as to avoid interference between the chips. An additional feature is the inclusion of a dongle door that is selectively detachable.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is an exploded side perspective view of a USB data card according to an embodiment of the present application.

FIG. 2A is a top plan view of the inside of a bottom cover in the USB data card of FIG. 1.

FIG. 2B is a top plan view of the inside of a top cover in the USB data card of FIG. 1.

FIG. 3 is a top view of a dongle door in the USB data card of FIG. 1.

FIG. 4 is a separated view of the dongle door of FIG. 3.

FIG. 5 is a rear perspective view of the dongle door of FIG. 3.

FIG. 6 is a top plan view of the USB data card of FIG. 1.

FIG. 7 is a bottom plan view of the USB data card of FIG. 1.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method in accordance with the present application overcomes one or more of the above-discussed problems commonly associated with the prior art discussed previously. In particular, the data card assembly is configured to distribute media including any one or all of music, videos and movies said card include a main card body formed of two covers that snap or nestle together about its perimeter. One or more chips are nestled internally within the main card body and are configured to transmit information. A USB male connector is configured to pivot relative to the main card body so as to operate between a retracted position and an extended position. The USB male connector is coupled to a dongle configured to pivot about an axis relative to the main card body. The USB male connector includes executable instructions to communicate with a remote third party notifying the time and location of access to stored information. These and other unique features are discussed below and illustrated in the accompanying drawings.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

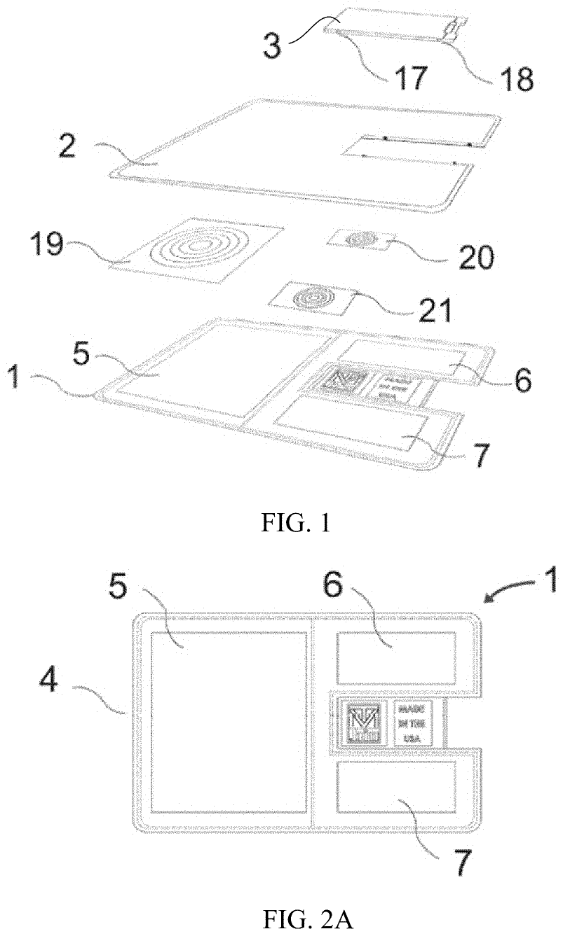

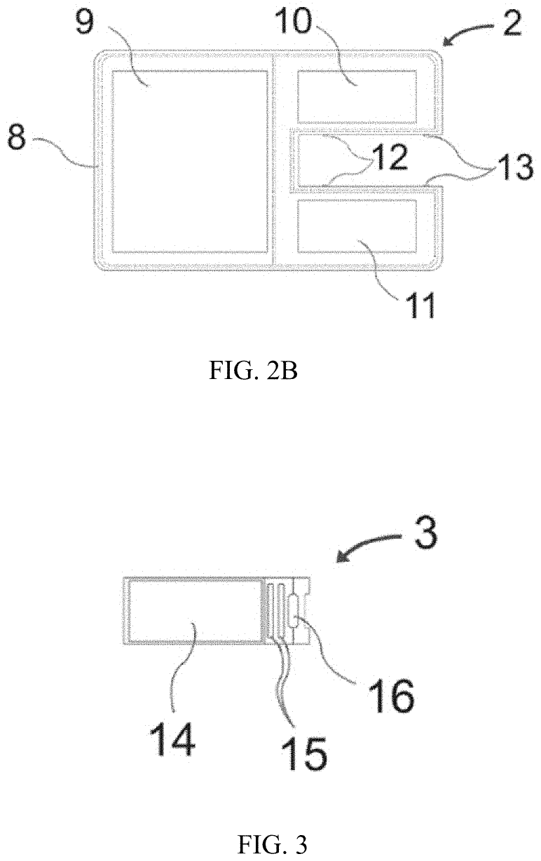

Referring now to FIGS. 1-2B in the drawings, a USB data card is illustrated. The present invention encompasses a data card and a method of distributing and promoting music, videos, or movies using said card.

As demonstrated in the various figures, the assembly includes a bottom cover 1 and a top cover 2. Covers 1 and 2 are opposing layers that are configured to nestle together along respective sides. Bottom cover 1 is constructed and arranged with a peripheral groove 4 around its perimeter and optionally with portions of its interior. Top cover 2 is configured to include a ridge or tongue protrusion 8 that matches the groove 4 so as to permit covers 1 and 2 to interlock together. This mating forms a singular two-part housing. It should be understood that the card assembly is, and specifically covers 1 and 2 may be attached to form an assembly by either gluing or sonic welding in some applications. As the housing includes two parts, each part may be manufactured with minimal thicknesses individually at far less cost than single molded housings. It is understood that groove 4 and protrusion 8 may be oriented, aligned, and routed to any portion of each cover 1 and 2.

Covers 1 and 2 are configured to include cavities or pockets for the acceptance and locating of one or more chips. Bottom cover 1 includes a formed cavity or a first pocket 5 constructed and arranged to hold any of a Radio-Frequency identification (RFID) chip(s,) Bluetooth chip(s), or any other chips that allow transfer of data through wireless communication. Top cover 2 likewise also includes a cavity or pocket 9 congruent with first pocket 5 of bottom cover 1. Bottom cover 1 further has second pocket 6 and third pocket 7 that are congruous with a first pocket 10 and second pocket 11 in top cover 2. Each pocket is constructed and arranged to hold any of a Radio-Frequency identification (RFID) chip(s,) Bluetooth chip(s), or any other chips that allow transfer of data through wireless communication.

It is understood that pockets or cavities may be formed in both covers 1 and 2 that when combined may fully shape and define a singular cover. Pockets or cavities in one cover may not necessarily correspond to an opposing cavity or pocket in the other cover. The desired depth of the cover may influence or dictate the exact sharing or number of depths in covers 1 and 2.

Referring now also to FIG. 3 in the drawings, the USB data card is configured to include a selectively deployable dongle. Dongle 3 includes a door. Dongle 3 is configured to hold the USB drive and is designed to be discretely hidden within the body of the card. This gives the card more surface to print graphics or information on the exterior.

Covers 1 and 2 are formed to accept dongle 3 in a retracted position. A dongle pocket may be formed as a recess in the perimeter of covers 1 and 2. In the retracted position, dongle 3 may reside within a portion of that recess and be relatively flush with the outer surface of the card assembly. Dongle 3 may be deployed wherein it is extended so as to reach outside the perimeter of covers 1 and 2. This may be done in many different manners. One such was is by pivoting dongle 3 about an axis. At least one of cover 1 and 2 may include a recessed aperture or conversely a protrusion. A corresponding and opposite aperture or protrusion may be found on dongle 3. In operation, dongle 3 may be snapped into place relative to covers 1 and/or 2 such that the protrusion enters the recessed aperture to permit pivoting of the dongle 3. These protrusions may be seen as a first pair of protrusions 12 and a second pair of protrusions 13 that are constructed and arranged to meet with first socket 17 and second socket 18 on dongle door assembly 3.

Door dongle 3 is formed to include a door dongle pocket 14 for securing a UDP chip or any other USB type chip. It also includes anti-slip thumb grooves 15 and a cavity 16 configured for coupling with a lanyard or any other clip and hook device. It is understood that dongle 3 may operate between the retracted and extended positions. Dongle 3 is also selectively detachable from the covers 1 and/or 2. The associated chip and the dongle 3 itself may be swapped out.

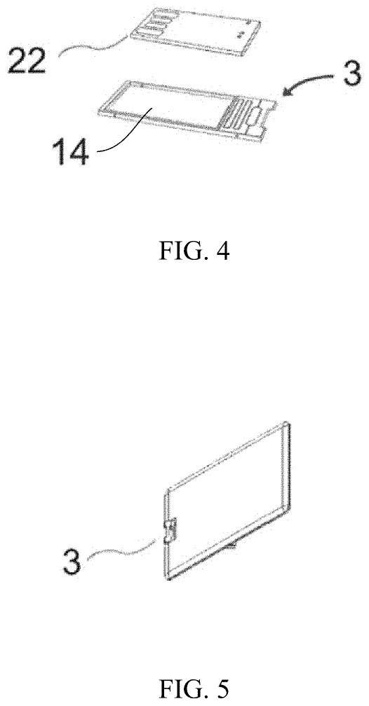

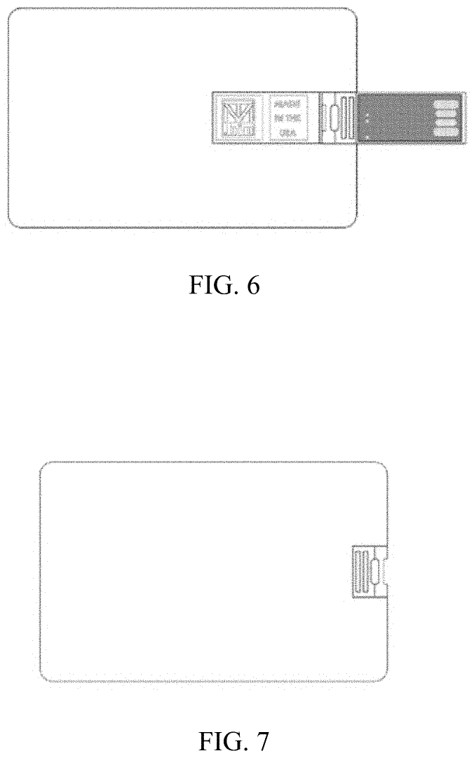

Referring now also to FIG. 4-7 in the drawings, more detailed views of dongle 3 and its associated chip are illustrated. Any type of chip 22 may be housed or located in pocket 14. For example, chip 22 in FIG. 4 may provide for Near Field Communication (NFC) 19. Likewise, other suitable chips may be a Bluetooth chip 20 or a Radio-Frequency identification (RFID) chip 21. The chips can be formed or configured and positioned in any combination and are not limited to the placement set forth in the figures. UDP (USB Disk In Package) or any other form of USB chip 22 are formed to mate with door dongle 3. Each chip in the data card of the present application is spaced apart from one another sufficiently to avoid interferences. The chips are configured to permit multiple types of communication and are suitable to communicate through all types of software platforms, as needed.

As generally understood, the invention is configured to selectively store movies, music, and/or other forms of data. This may serve as a replacement for the cd (compact disc) and dvd. Although many the card assembly may take many forms, the card assembly of the present application is ideally between 2 mm and 5 mm thick when each of bottom cover 1 and top cover 2 are attached on to the other. In another embodiment, the card assembly is 3-4 mm thick.

The size and shape of the card assembly dictates the amount of surface is permitted to accept graphical indicia. This may be spread over covers 1 and 2 as well as portions of dongle 3. The chips may be inserted or exchanged at any time during construction. For example, graphical indicia may be printed and then subsequently one or more chips may be inserted into the cavities/pockets. This allows the printing and manufacturing to be done independently from that of the assembly.

The card assembly may be made from assorted materials such as plastics. An example of a material would be that of ABS (Acrylonitrile Butadiene Styrene).

In way of safety and security, it is desired that the card assembly includes a design that would cause the chips to destruct if the body was ripped open, thereby destroying the chips and the data. The card assembly is shown as having 3 cavities to house multiple styles of chips. These cavities are distanced so one chip does not interfere with the frequencies of the others. Placement of the cavities is very important to the design and user friendliness to customers to locate the correct spot when engaging with electronic devices.

The card assembly is useful for many types of industries and is configured to provide an assortment of key features and functions. These features and functions may be best illustrated through the following examples.

The card assembly of the present application may be a USB Music Card. It is a medium that holds music, movies and videos from various artists that can be played on any MAC, Windows, tablet, Android phone, or Smart TV. It's a 2-4 mm thick piece of plastic, business card size, with a dongle that connects to electronic devices. This would have an artist's album artwork on the front with sponsors on the back as graphical indicia. The USB Music Card contains smart links that can let an artist know when (day, month, year) and where (city, state, and country) the card is being played in live time. Also, there is a chip, such as a Radio Frequency identification (RFID), Near Field Communication (NFC), and/or Bluetooth, to be inserted and sealed in the plastic casing. This allows for the front and back printing to be completed first thereby reducing cost and manufacturing time.

As a musician, it is important to know when and where the music is being played and sold. USB Music Cards provide the artist the smartest merchandise on the planet! This is the only item that an artist can sell that will give analytics of use and location in real time. The USB connector may include smart links configured to transmit data to a remote third party. For example, the artist will know the time when (day, month, year) and where (City, State, Country) fans are listening to the music. These analytics will help the artist decide if he/she needs more concerts or live performances in certain parts of the country. It would also help to convey to corporate sponsors who and where the artist's demographics are. The time and location are transmitted to a remote third party.

In use, an easy to use Menu appears when the card assembly is plugged into a computerized device. Through this menu, a user is permitted selected functions and personalizations. For example, a user may adjust and/or access information related to:

Music—organize all their amazing tracks in order with NO internet connection, ads to disrupt the mood, or expensive data charges

Artist Bio—takes your fans to any one or more web pages with all social media links and other albums that can be purchased

Video—include music videos or custom “thank you” videos to your fans for their support

Back Stage—special pictures or videos to your fans as an added bonus for purchasing your album. For example: behind the scenes video clips, special album artwork, unreleased pictures of the band

Sponsors—including your sponsors is a great way to cover your cost and show gratitude for their support

Reward loyal music fans with addition content such as pictures, extra music tracks, or even a personal video thanking them

Get music sponsors by putting their logo on the exterior of the card

Music Sponsors love that there is an introduction video that can be up to 5 minutes when the Card of the invention is first played

Track who is playing your music in LIVE TIME (Country, City, and State) and transmitting that data to a remote third party

Easy to sell and distribute at concerts, night clubs, festivals, and trade shows because they are the size of a business card

Gain maximum exposure at shows because it goes around music fans necks with a stylish lanyard

Increase music sales by knowing where your music is selling or if you need to market to certain areas where you music would be best loved

No more guessing if live performances are generating music sales. Know instantly if you are a hit with the crowds!

Plays on all music devices instantly (cars with USB port, computers, MAC's, all Android phones, will pay through your phone's bluetooth or headphone jack)

As noted above, the card assembly of the present application may include Near Field Communication. NFC technology allows a user to touch a mobile phone to the USB Music Card and allow fans to be taken right to the artist's Profile Page associated with the card assembly. This is similar to technology used to pay at cash registers at time of checkout.

A QR Code may be placed on the USB Music Card so music lovers can quickly get to a created Profile Page associated with the card of the invention. Once there, they can follow the social media links or purchase other albums. All data is tracked in live time.

The USB allows the artist's USB Music Card to be played on any device that supports the connection. Whether it's a Mac, Windows, Smart TV, tablet, or 95.7% of other computing devices, it can be sure to play the USB Music Card of the present application.

In one embodiment, the present invention is a card for distributing media including any one or all of music, videos and movies said card comprising:

a main card body having substantially flat and parallel upper and lower planar surfaces; and

a USB male connector constructed and arranged having a first unfolded configuration whereby said USB connector is substantially within the periphery of the card, and an unfolded configuration whereby said USB connector utilizes a living hinge to extend away from the planar surface of said card and is accessible for insertion into a USB receiving port.

In another embodiment, the present invention is a card including at least one communications device including at least one of Near Field Communication (NFC) chip, Bluetooth communications device, Radio-Frequency identification (RFID) chip, UDP (USB Disk In Package), or combinations thereof.

In yet another embodiment, the present invention is a method of distributing music, videos, and movies and interacting with patrons of said music said method comprising the steps of:

providing a card assembly having a plurality of covers, whereby said card is preconfigured with music and information, the information including automatically executable instructions to connect to a preselected website when said card is inserted into a USB port of a computing device connected to the Internet; and

optionally accessing said preselected website and uploading information relating to at least one of a place of card acquisition, the number of times said preselected website is accessed with a particular card, uploading payment and purchase of any one of music, videos, movies, clothing or promotional items, or combinations thereof.

Additionally, the present invention is a method of interacting at a trade show, the method comprising the steps of:

providing a card assembly having a plurality of covers, whereby said card is preconfigured with information relating to at least one particular trade show or with a user selectable list of trade show information, said information including automatically executable instructions to connect to a preselected website when said card is inserted into a USB port of a computing device connected to the Internet;

exchanging information between attendee card holders and exhibitors using NFC chips in said card;

providing said exhibitors software to interact with said cards to create a “note” section for follow ups on each attendee that enters an exhibitor booth; and

optionally, configuring said pre selected website as a communication link between cardholders and exhibitors.

In one embodiment, the present invention provides a method by which cards of the present invention will be used as passes to enter trade shows. Contemplated advantages include:
Quicker entry into trade show because of NFC chips
Exhibitors (business selling at trade shows) can now capture attendees information using out NFC chips
Exhibitors will have a “note” section for follow ups on each attendee that enters their booth to increase ROI for trade show overhead costs
Exhibitors get charge by weight for printed material that is handed out. You will not need to hand out material because all the Exhibitor's pamphlets, brochures, or printed material now can be saved to our USB drive via the UDP chip.

In one embodiment, the present invention is a card for distributing media including any one or all of music, videos and movies said card comprising:

a main card body formed of connected top cover and bottom cover having substantially flat and parallel upper and lower planar surfaces;

a USB male connector constructed and arranged having a first unfolded configuration whereby said USB connector is substantially within the periphery of the card, and

an unfolded configuration whereby said USB connector utilizes a hinge to extend away from the planar surface of said card and is accessible for insertion into a USB receiving port.

In one embodiment, the present invention is a card including at least one communications device nested within said connected top cover and bottom cover including at least one of Near Field Communication (NFC) chip, Bluetooth communications device, Radio-Frequency identification (RFID) chip, UDP (USB Disk In Package), or combinations thereof.

In one embodiment, the present invention is a method of distributing music, videos, and movies and interacting with patrons of said music said method consisting of the steps:

providing a card according to the present invention, whereby said card is preconfigured with music and information, said information including automatically executable instructions to connect to a preselected website when said card is inserted into a USB port of a computing device connected to the Internet;

optionally accessing said preselected website and uploading information relating to at least one of a place of card acquisition; number of times said preselected website is accessed with a particular card; and

uploading payment and purchase of any one of music, videos, movies, clothing or promotional items; or combinations thereof.

In one embodiment, the present invention is a method of interacting at a trade show, said method consisting the steps of:

providing a card according to the present invention, whereby said card is preconfigured with information relating to at least one particular trade show or with a user selectable list of trade show information, said information including automatically executable instructions to connect to a preselected website when said card is inserted into a USB port of a computing device connected to the Internet;

exchanging information between attendee card holders and exhibitors using NFC chips in said card;

providing said exhibitors software to interact with said cards to create a “note” section for follow ups on each attendee that enters an exhibitor booth; and

optionally, configuring said pre-selected website as a communication link between cardholders and exhibitors.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A card for distributing media including any one or all of music, videos and movies said card comprising:
a main card body formed of connected a top cover and a bottom cover having substantially flat and parallel upper and lower planar surfaces; the top cover and bottom cover coupled via interference fit via a groove and protrusion about the perimeter of the top cover and the bottom covers, the top cover and the bottom cover together forming a plurality of pockets internally within the main card body;
a USB male connector configured to pivot relative to the main card body, the USB male connector coupled to a dongle configured to pivot about an axis relative to the main card body, the dongle operating between a retracted and extended position.

2. The card of claim 1, further comprising:
at least one communications device nested between said connected top cover and bottom cover within the plurality of pockets including at least one of a Near Field Communication (NFC) chip, a Bluetooth communications device, a Radio-Frequency identification (RFID) chip, a UDP (USB Disk In Package), or combinations thereof.

3. The card of claim 1, wherein the main card body is 2-5 mm thick.

4. The card of claim 1, wherein the USB male connector includes smart links to transmit a date and location associated with the access of data from the USB male connector to a remote third party.

5. The card of claim 4, further including at least one communications device nested between said connected top cover and bottom cover within the plurality of pockets to include at least one of a Near Field Communication (NFC) chip, a Bluetooth communications device, a Radio-Frequency identification (RFID) chip, a UDP (USB Disk In Package), or combinations thereof.

6. The card of claim 4, further including at least two different communications devices nested between said connected top cover and bottom cover within the plurality of pockets, the communications devices are any two of a Near Field Communication (NFC) chip, a Bluetooth communications device, a Radio-Frequency identification (RFID) chip, and a UDP (USB Disk In Package).

7. The card of claim 4, further including at least three different communications devices nested between said connected top cover and bottom cover within the plurality of pockets, the communications devices are any three of a Near Field Communication (NFC) chip, a Bluetooth communications device, a Radio-Frequency identification (RFID) chip, and a UDP (USB Disk In Package).

8. The card of claim 4, wherein the card is preconfigured with information and automatically executable instructions to connect to a preselected website when said card is inserted into a USB port of a computing device connected to the Internet.

9. The card of claim 1, further including a dongle pocket formed into the main body, the dongle pocket having a door that pivots the USB male connector between the folded and unfolded configurations, the door configured to cover the dongle pocket in the folded configuration.

10. The card of claim 1, wherein the hinge is a living hinge.

11. A method of distributing music, videos, and movies and interacting with patrons of said music said method comprising the steps of:
providing a card according to claim 1, whereby said card is preconfigured with music and information, said information including automatically executable instructions to connect to a preselected website when said card is inserted into a USB port of a computing device connected to the Internet;
accessing said preselected website and uploading information relating to at least one of a place of card acquisition; number of times said preselected website is accessed with a particular card; and
uploading payment and purchase of any one of music, videos, movies, clothing or promotional items; or combinations thereof.

12. The method of claim 11, wherein the USB connector includes smart links to transmit a time and location associated with the access of data from the USB connector to a remote third party.

13. The method of claim 11, wherein the USB male connector includes smart links to track who is playing music through the USB male connector.

14. The method of claim 13, further comprising:
tracking sales of music and location of access to isolate key market areas.

15. A method of interacting at a trade show, said method comprising the steps of:
providing a card according to claim 1, whereby said card is preconfigured with information relating to at least one particular trade show or with a user selectable list of trade show information, said information including automatically executable instructions to connect to a preselected website when said card is inserted into a USB port of a computing device connected to the Internet;
exchanging information between attendee card holders and exhibitors using NFC chips in said card;
providing said exhibitors software to interact with said cards to create a “note” section for follow ups on each attendee that enters an exhibitor booth; and
configuring said pre-selected website as a communication link between cardholders and exhibitors.

16. The method of claim 15, wherein the USB male connector includes smart links to transmit a time and location associated with the access of data from the USB connector, the transmission going to a remote third party.
